(19) United States
(12) Patent Application Publication
(10) Pub. No.: US 2025/0163752 A1
(43) Pub. Date: May 22, 2025

(54) INSULATING GLASS PANE WITH GLAZING BAR INSERT AND DEVICE

(71) Applicant: Glaston Germany GmbH, Neuhausen-Hamberg (DE)

(72) Inventor: Gennadi Schadrin, Remchingen (DE)

(73) Assignee: Glaston Germany GmbH, Neuhausen-Hamberg (DE)

(21) Appl. No.: 18/947,536

(22) Filed: Nov. 14, 2024

(30) Foreign Application Priority Data
Nov. 16, 2023 (DE) 10 2023 131 970.1

(51) Int. Cl. E06B 3/663; E06B 3/263

(52) U.S. Cl. CPC E06B 3/66304; E06B 3/263; E06B 2003/26392

(57) ABSTRACT

An insulating glass pane has at least two glass sheets, a frame-shaped spacer and a glazing bar insert, as well as a method and a device for their manufacture. The glazing bar insert is mounted inside the spacer between the two glass sheets. The glazing bar insert includes at least one elongated glazing bar profile with a glazing bar end facing the spacer. At least one glazing bar end is formed by a glazing bar profile being formed as hollow profile and is embedded in the plastic-based material of the spacer in such a way that part of the plastic-based material is present in the interior of the hollow profile.

### CROSS-REFERENCE TO RELATED APPLICATIONS

This application claims priority to the German application number DE 10 2023 131 970.1 filed on Nov. 16, 2023, the entire content of which is fully incorporated herein with this reference.

### DESCRIPTION

### Field of the Invention

The invention is based on an insulating glass pane comprising at least two glass sheets, a frame-shaped spacer and a glazing bar insert. The glazing bar insert is mounted inside the spacer between the two glass sheets. The glazing bar insert contains at least one elongated glazing bar profile with a glazing bar end facing the spacer.

### Background of the Invention

One such insulating glass pane is known from DE 295 14 622 U1. The insulating glass pane has a frame-shaped spacer, which consists of a thermoplastic spacer strand and is arranged between two glass sheets. A glazing bar insert arranged between the glass sheets has glazing bars formed from hollow profiles. The glazing bar insert, known as glazing bar frame, is not fixed to the glass sheet by means of the thermoplastic spacer, but separately from it. A glazing bar frame is used for this purpose, the glazing bars of which are thinner than the specified spacing of the glass sheets of the insulating glass panes. The glazing bars have end pieces that are either as thick as the specified spacing or are compressible and slightly thicker than the specified spacing of the glass sheets. The length of the glazing bars, including their end pieces, is selected to be 1 to 2 mm smaller than the clear width of the frame-shaped spacer bar extruded onto one glass sheet, measured along the length of the glazing bars. In addition, the end pieces of the glazing bars are designed to be adhesive on at least one side facing the two glass sheets. A glazing bar insert prepared in this way is aligned with the spacer extruded onto the one glass sheet and inserted into the space enclosed by the spacer and bonded to the glass sheet in such a way that the end pieces do not touch the spacer. The second glass sheet is then placed on the spacer and the semi-finished insulating glass pane formed in this way is pressed to set the specified distance between the glass sheets. The end pieces are not pressed into the spacer bar, causing the spacer to ripple. This prevents the spacer from becoming wavy.

An insulating glass pane of the type mentioned at the beginning with a thermoplastic spacer is also known from DE 10 2004 043 581 A1. A glazing bar holder designed as a glazing bar end piece is disclosed, which has means for anchoring to the spacer (pointed spikes). The glazing bar end piece is first pressed into the inner side surface of the spacer strand before it is attached to the glazing bars. A counter-holder, which does not adhere to the thermoplastic spacer, is applied to the side surface of the spacer strand facing away from the glazing bar end piece in order to prevent deformation of the still soft spacer strand. At least one glazing bar holder per glazing bar is designed in such a way that the end of the glazing bar can be inserted transversely to its longitudinal direction into the holder. During insertion, the glazing bar end piece stabilises the spacer strand. The free ends of the glazing bars therefore do not directly contact the spacer strand, but rather the associated glazing bar end piece that is already anchored to the spacer strand. The glazing bar end only acts directly on the glazing bar end piece, but not on the spacer strand. This is intended to limit the introduction of forces into the thermoplastic spacer to an uncritical level.

DE 10 2019 123 700 A1 discloses an insulating glass pane in which the frame-shaped spacer is formed by placing two pasty and subsequently solidifying spacer strands on top of each other, the combined height of which results in the height of the spacer. One spacer strand is applied to each of the two glass sheets. Before the two glass sheets are joined together, a glazing bar frame is placed on the spacer strand of one of the glass sheets. For this purpose, a T-shaped retaining element is attached to each end of the muntin bar as seen from the side, which is pressed slightly into a surface of the still soft material of the spacer strip that is parallel to the glass sheet. In the finished insulating glass pane, half of the retaining elements of the glazing bar frame are then embedded in one of the two spacer strands.

It may be an object of the invention to improve the quality of insulating glass panes with inserted glazing bars and to create a method and a device for assembling such insulating glass panes.

This object of the invention has been achieved by an insulating glass pane having the features specified in claim 1, a device having the features specified in claim 4 and a method having the features specified in claim 10. Advantageous further embodiments of the invention are subject of the dependent claims.

### SUMMARY OF THE INVENTION

The insulating glass pane according to the invention comprises at least two glass sheets and a frame-shaped spacer made of a plastic-based material. The spacer and the glazing bar insert are arranged between the two glass sheets. The spacer is formed by a pasty and subsequently solidifying strand of a plastic-based material. A glazing bar insert is attached to the spacer.

The glazing bar insert comprises at least one glazing bar with two ends configured for attachment to the spacer. The glazing bar insert consists of at least one single glazing bar. However, the glazing bar insert can also contain an arrangement of several intersecting glazing bars. Such an arrangement is sometimes also referred to as a “glazing bar frame”. A glazing bar can be formed by an elongated glazing bar profile. The glazing bar profile is formed as a hollow profile. A glazing bar can also be composed of several glazing bar profiles. The glazing bar profiles can be thin-walled hollow profile bars. The glazing bar insert comprises at least one elongated glazing bar profile with a glazing bar end facing the spacer. According to the invention, at least one glazing bar end is formed by a glazing bar profile being formed as hollow profile and embedded in the plastic-based material of the spacer in such a way that part of the plastic-based material is present in the interior of the hollow profile. The free end of the elongated glazing bar profile is embedded directly in the spacer strand. The hollow profile is open at the embedded glazing bar end. During embedding, some of the plastic-based material of the spacer is therefore pressed into the open end of the glazing bar. The glazing bar profile extends into the spacer. There is therefore a direct connection between the glazing bar profile and the plastic-based material of the spacer at the end of the glazing bar. This means that neither a glazing bar holder nor a glazing bar end piece is used.

In the process according to the invention, the spacer is applied to a first glass sheet in the form of a frame from a pasty and subsequently solidifying spacer strand. The spacer strand is a pasty and thereafter solidifying spacer strand made of a thermoplastic material and/or a reactive crosslinking material. A method and a device for applying a plastically deformable strand as a spacer are known from DE 44 33 749 A1. The spacer strand can be applied to the first glass sheet with a predetermined nominal thickness. The pasty spacer strand is therefore still hot and/or not yet fully cured both during application and after application, i.e., the material is still soft and easily plastically mouldable. The glazing bar insert is inserted into the still pasty material of the spacer strand and the end of the glazing bar is embedded. After applying the spacer to the first glass sheet, at least one section of the still pasty spacer strand is bent outwards, i.e., towards the edge of the glass sheet. The spacer strand is plastically deformed so that the clear internal dimension in this section of the frame-shaped spacer increases.

Embedding takes place by inserting the glazing bar insert into the space enclosed by the frame-shaped spacer and bending back the bent-open spacer strand. At least one glazing bar end of the glazing bar insert presses into the still pasty spacer strand and the plastic-based material of the spacer strand deforms plastically. The material of the spacer strand is pressed into the open end of the glazing bar profile in the longitudinal direction of the glazing bar profile during embedding. After pressing in, part of the plastic-based material is present in the interior of the hollow profile. The glazing bar profile can be embedded at its end more than 0.5 mm, in particular, 0.8 mm to 1.2 mm, deep into the spacer strand. The spacer thus holds the glazing bar insert in position directly and immediately by the embedded end of the glazing bar profile. The glazing bar insert can have a distance to both glass sheets. After embedding the end of the glazing bar in the spacer strand, a second glass sheet is placed on the frame-shaped spacer so that the spacer and the glazing bar insert are located between the two glass sheets. The space between the glass sheets can be filled with a gas other than air in a manner known per se. One single spacer bar can be arranged on the first glass sheet. There can be no spacer bar on the second glass panel. In particular, one single spacer strand can be applied exclusively on the first glass sheet. The two glass sheets of the insulating glass pane can be particularly held at a distance to each other by one single spacer strand.

The device according to the invention for assembling the insulating glass panes comprises a glazing bar station configured for inserting a glazing bar insert. The glazing bar station according to the invention is configured to insert a glazing bar insert into a frame-shaped spacer, which was formed on a first glass sheet by applying a pasty and subsequently solidifying spacer strand along the edge of the glass sheet. The device contains at least one bending-up device which is configured to plastically bend outwards a spacer strand applied to a glass sheet. The bending-up device can contain a strand bending tool that can be moved towards the edge of the glass sheet in order to deform a section of the spacer strand outwards. The device contains at least one bending-back device, which is configured to plastically bend back a bent-open spacer strand after insertion of a glazing bar insert. The bending-back device can contain a strand bending tool that can be moved towards the centre of the glass sheet in order to deform a section of the spacer strand inwards. In the process, a glazing bar end of a glazing bar insert positioned inside the spacer is pressed into the still soft material of the spacer strand and thereby embedded.

For decades, the prevailing opinion among experts was that a spacer strand made of a paste-like material that had not yet hardened should not be deformed and/or subjected to forces after application onto the first glass sheet in order not to impair the appearance of the spacer in the finished insulating glass pane. For this reason, any deformation of the spacer strand and the introduction of forces acting laterally and/or parallel to the glass sheet (forces not acting along pressing direction of the two glass sheets) into the still soft material of the spacer strand has been avoided or minimised. Based on this opinion, the teaching described in DE 295 14 622 U1 was developed in 1995, in which glazing bar end pieces are used that do not touch the spacer strand. The solution developed around 10 years later according to DE 10 2004 043 581 A1 is also still characterised by this opinion. The present invention has now surprisingly shown that the previously prevailing opinion is incorrect. On the contrary, the goal-oriented bending up and back of the spacer strand according to the present invention makes it possible to produce insulating glass panes which have a very clean, neat and visually appealing appearance. The controlled deformation and subsequent embedding of the glazing bar end are, contrary to expectations, easily and safely controllable, in particular, when a mechanical device according to the present invention is used.

The invention may have (but which are not necessary) further significant advantages:

No glazing bar end pieces and/or glazing bar shoes are required. This simplifies the assembly process when installing the glazing bar insert.

The insertion of the glazing bar insert into the spacer can be easily automated. This ensures very precise positioning of the glazing bar insert in the frame-shaped spacer or in the insulating glass pane.

Embedding the glazing bar insert in the spacer allows the glazing bar insert to be positioned between the two glass sheets in such a way that the glazing bar insert does not touch either of the two glass sheets. This is particularly advantageous if the glass sheets have a coating on their inward-facing surface.

The embedded glazing bar end offers a very visually appealing appearance. In particular, length tolerances of the glazing bars disappear by embedding them in the spacer bar and are no longer visible. This allows much greater tolerances for the glazing bar inserts, making their production much simpler and more cost-effective.

Once the spacer strand has fully cured, the glazing bar insert is firmly and securely fixed in the insulating glass pane, in particular, without play.

Overall, the appearance and quality of insulating glass panes with an inserted glazing bar frame can be improved.

In an embodiment of the invention, the glazing bar insert can have two glazing bar ends facing the spacer, which lie opposite each other and are each formed directly by a glazing bar profile being formed as hollow profile. Both glazing bar ends are embedded in the spacer strand wherein plastic-based material of the spacer (4) is present in the interior of the hollow profile at both glazing bar ends. The glazing bar insert can have an external dimension measured along the glazing bar profile over the two glazing bar ends, which is larger than the associated internal dimension of the frame-shaped spacer. The internal dimension is measured at the point of the spacer at which the two opposite ends of the glazing bar are embedded in the spacer strand. It corresponds to the clear internal dimension of the spacer. Two opposite sections of the spacer strand are bent outwards in such a way that the internal dimension is increased there. When inserting the glazing bar insert, the external dimension of the two opposite glazing bar ends is smaller than the enlarged internal dimension between the bent-up sections of the spacer strand. During embedding, the bent-up sections of the spacer strand are bent back to the internal dimension that existed before bending up. The glazing bar insert can comprise several glazing bars. Each glazing bar can have a free end, which is formed by a glazing bar profile and embedded in the plastic-based material of the spacer.

In a further embodiment, the spacer strand can have a rectangular cross-section and one of its narrow sides can be applied to the first glass sheet. The spacer strand can have two opposing side surfaces, both of which are orientated transversely to a glass plane of the first glass sheet. An inner side surface faces the centre of the glass sheet. An outer side surface faces outwards towards the edge of the glass sheet. A bending force is applied to a side surface of the spacer strand in order to plastically deform a section of the spacer strand outwards, in particular, with the bending-up device. In particular, an area of the spacer strand at a distance from the glass sheet is bent outwards. The narrow side of the spacer strand adhering to the first glass sheet is not deformed. A bending-back force is applied to a side surface of the spacer strand in order to plastically deform the bent-up section inwards, i.e., towards the centre of the glass sheet, in particular, with the bending-back device. When bending back, the spacer strand is returned to its original shape, which it had before being bent open, in particular, to the rectangular shape extending in a straight line. The bending-up force and the back-bending force are each a force orientated along the plane of the glass, in particular, a compressive force. The bending-back force and the bending-up force can be applied to opposite side surfaces of the spacer strand. In particular, the bending-up force can be exerted on the inner side surface and the bending-back force on the outer side surface of the spacer strand.

The device can have several stations for carrying out different work steps, in particular, an application station. The application station is configured for applying a pasty and subsequently solidifying spacer strand of a plastic-based material along an edge of a glass sheet. The glazing bar station is arranged downstream of the application station. The device can include a control system which is coupled to the application station and the glazing bar station. The control system is configured to control the stations for assembling an insulating glass pane. Each of the stations has a horizontal conveyor on which the glass sheets are transported upstandingly one behind the other. Each horizontal conveyor is assigned a supporting wall on which the upstanding glass sheets are supported, tilted backwards by a few degrees.

In the application station, a pasty and subsequently solidifying spacer strand is applied onto a standing glass sheet, namely onto the first glass sheet, along its edge in a manner known per se. This means that no pre-assembled spacer frame is placed on the glass sheet. The spacer strand can be applied gap-free along the edge of the glass sheet. A spacer frame is only formed by a spacer strand applied along the entire edge of the glass sheet in order to keep two neighbouring glass sheets at a distance. The application station can contain an application head that can be guided along at least one section of the edge of the glass sheet in order to apply the spacer strand. For this purpose, the application head can contain a nozzle for extruding the paste-like material into a spacer strand. Once the frame-shaped spacer has been applied, the first glass sheet is conveyed upstandingly from the application station to the glazing bar station.

The bending-up force and/or the back-bending force can be controlled based on the temperature of the spacer strand. For example, the control system can record the time of application of the spacer strand to the first glass sheet as an electronic time stamp. The control system can then determine the time that has elapsed since the spacer strand was applied in the application station when bending up and bending back. From this, the control system can calculate how far the pasty material has already hardened and what force must be applied to plastically deform the spacer strand. The processing head can contain a temperature sensor which is configured to detect the temperature of the spacer strand, in particular, without contact. The temperature sensor is coupled to the control system. The control system can use the temperature of a spacer strand made of a thermoplastic material to calculate its strength and control the tools accordingly.

In a further embodiment, the device can have at least one movable processing head, which contains a gripper with two clamping jaws. The distance between the clamping jaws is variable for gripping a glazing bar profile. The gripping movement direction of the clamping jaws extends along the supporting wall and/or along the glass sheet. The gripper can be used to position the glazing bar insert parallel to the first glass sheet in the space enclosed by the frame-shaped spacer. The ends of the glazing bars do not yet touch the spacer strand. The processing head also contains the bending-up device and/or the bending-back device, in particular, both. The processing head thus forms an assembly with several processing tools, which can be moved as a whole to the required position on the spacer strand or the glass sheet, in particular, along and transversely to the supporting wall of the glazing bar station. The processing head can be swivelled around an axis extending transversely to the supporting wall. Depending on the course of the spacer strand (vertical, horizontal, inclined or curved), particularly in the case of non-rectangular model panes, the processing head can be rotated into the required position. In particular, the glazing bar station can contain several processing heads, for example 8 to 12. This ensures fast installation of glazing bar inserts with many glazing bar ends to be embedded. The processing heads can be moved independently of each other. A group of processing heads can be moved together, in particular, by being arranged on a guide beam. This can simplify the drive and control of the processing heads.

In an embodiment, the processing head can contain at least one positioning aid. The positioning aid is configured to position a glazing bar insert to be inserted between the clamping jaws. The positioning aid brings the glazing bar insert into a predefined position in relation to the clamping jaws before the glazing bar insert is clamped by closing the gripper. This makes it easier for a machine operator to manually insert the glazing bar insert into the gripper(s). The positioning aid can be movable relative to the gripper. After gripping the glazing bar insert, the positioning aid can be moved into a position in which it does not hinder the further insertion process. The positioning aid can include a support plate. The support plate is orientated transversely to the glazing bar profile. The support plate can be displaceable in relation to the gripper in a direction extending transversely to the supporting wall. This allows the support plate to be moved out of the area of the gripper after the glazing bar insert has been gripped. The positioning aid can contain at least one guide finger, which can be swivelled about an axis extending transversely to the supporting wall. The guide finger can be displaceable in relation to the gripper in a direction extending transversely to the supporting wall.

The bending-up device and/or the bending-back device can contain at least one strand bending plate. The strand bending plate can be moved along the glass plane in order to plastically deform the spacer strand. The strand bending plate can be moved relative to the clamping jaws to bend back the spacer strand. The direction of movement of the strand bending plate is orientated along the supporting wall and transverse to the gripping movement of the clamping jaws. The strand bending plate can be designed as a pressure plate in order to apply a compressive force to the spacer strand, in particular, to its outer side surface. The strand bending plate can have a non-stick coating to prevent the pasty material of the spacer strand from sticking to the strand bending plate.

In a further embodiment of the invention, the bending-up device can include at least one blowing nozzle, in particular, two blowing nozzles. The bending-up force can be applied by applying a flow of blown air to the inner side surface of the spacer strand. This can lead to accelerated cooling of a still hot spacer strand made of a thermoplastic material. This can increase the rigidity and/or load-bearing capacity of the pasty spacer strand when embedding the glazing bar profile. This ensures that the spacer strand has sufficient strength after embedding to hold the dead weight of the glazing bar insert without-then undesirable-plastic deformation. The flow of blown air enables non-contact bending. This means that no undesirable imprints from a bending tool can occur on the inner side surface of the spacer strand. The blowing nozzles can be attached to the clamping jaws and can be moved with them. This allows the size of the section of the spacer strand to be bent open to be adapted to the cross-sectional size of the glazing bar profile. The direction of the blown air flow can be orientated along the supporting wall or the glass plane, in particular, parallel to it. The direction of the blown air flow can be orientated obliquely to the longitudinal direction of the spacer strand.

In a further embodiment, the bending device can be designed as a suction device. The suction device can contain a suction nozzle configured to pull on the spacer strand on its outer side surface by suction. In this way, undesirable marks on the inner side surface of the spacer strand can also be avoided.

### BRIEF DESCRIPTION OF THE DRAWINGS

Further details and advantages of the invention are explained by means of embodiments of the invention with reference to the accompanying drawings. Identical and corresponding components are provided therein with corresponding reference symbols.

FIG. 1 shows a perspective view of an insulating glass pane with glazing bar insert according to the invention;

FIG. 2 shows a partially sectioned front view of the insulating glass pane of FIG. 1;

FIG. 3 shows an enlarged view of area III of FIG. 2;

FIG. 4 shows a perspective view of a first glass sheet of the insulating glass pane of FIG. 1 after the application of a spacer strand;

FIG. 5 shows the glass sheet of FIG. 4 after the spacer strand has been bent open;

FIG. 6 shows the glass sheet of FIG. 4 with inserted glazing bar insert;

FIG. 7 shows a front view of the glass sheet of FIG. 6;

FIG. 8 shows a sectional view along the cut surface VIII-VIII of the glass sheet of FIG. 7;

FIG. 9 shows an enlarged view of area IX of FIG. 8;

FIG. 10 shows a perspective view of a schematically depicted device for applying a spacer strand and inserting a glazing bar insert when assembling an insulating glass pane of FIG. 1;

FIG. 11 shows is a schematic front view of a glazing bar station for the device of FIG. 10;

FIG. 12 shows a first embodiment of a processing head for the glazing bar station of FIG. 11;

FIG. 13 shows the processing head of FIG. 12 after gripping the glazing bar insert;

FIG. 14 shows a view similar to FIG. 13 of a second embodiment of a processing head; and

FIG. 15 shows a view similar to FIG. 13 of a third embodiment of a processing head.

### DETAILED DESCRIPTION OF EMBODIMENTS OF THE INVENTION

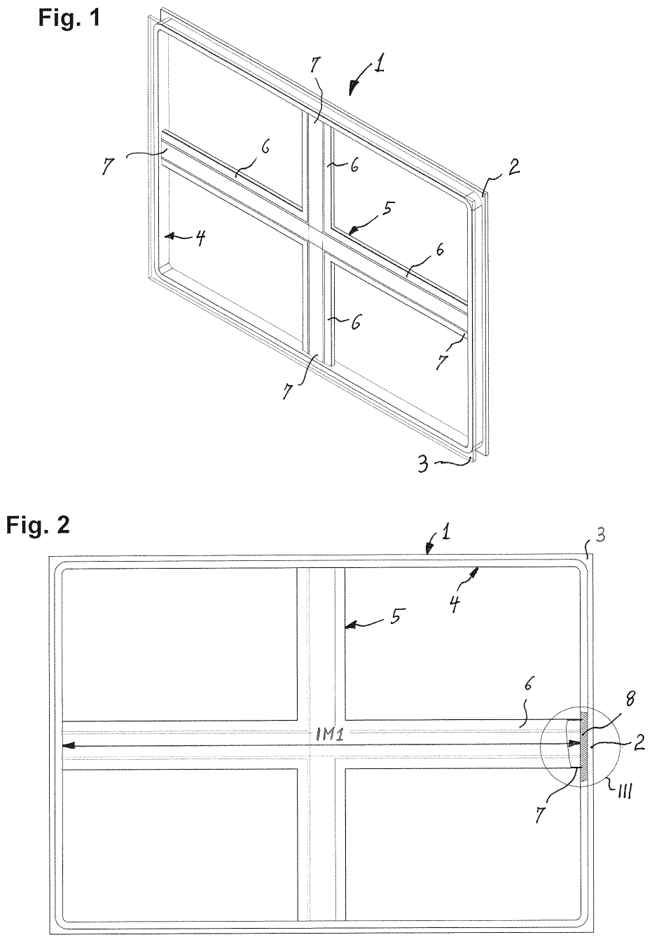

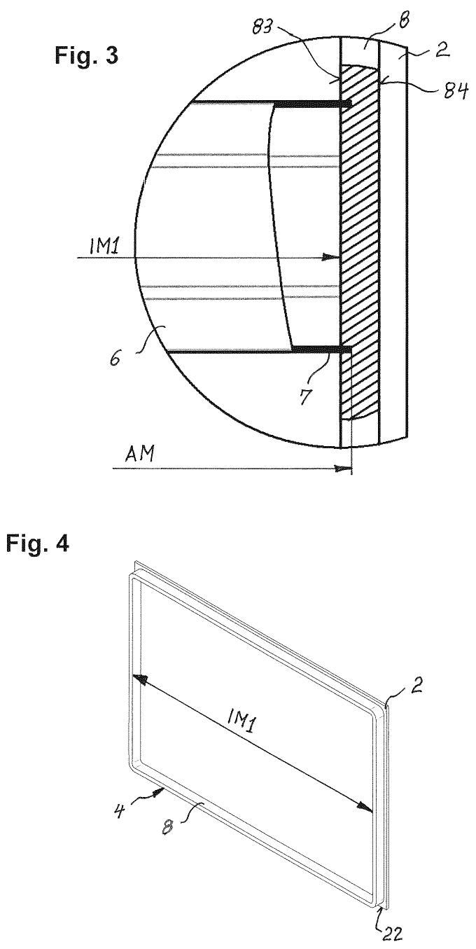

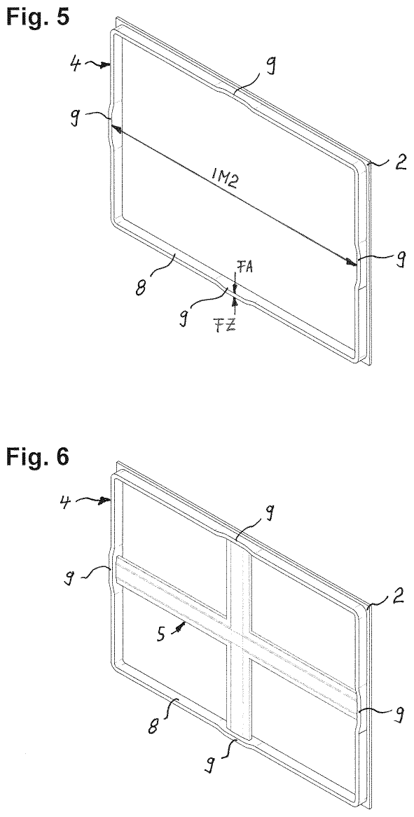

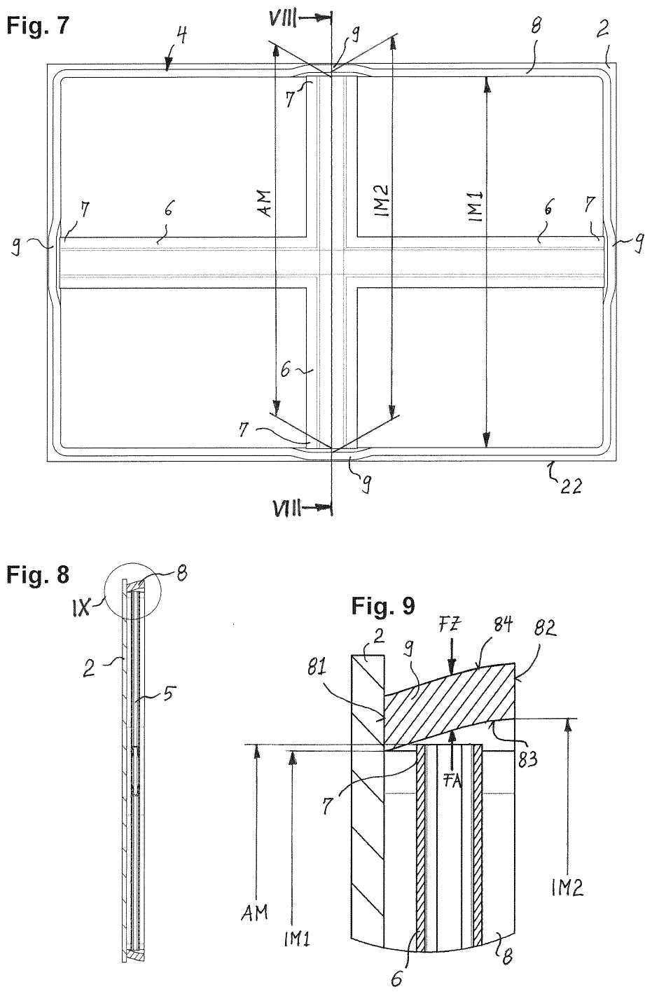

FIGS. 1 and 2 show an insulating glass pane 1 according to the invention, which comprises a first glass sheet 2, a second glass sheet 3, a frame-shaped spacer 4 and a glazing bar insert 5. The glazing bar insert 5 contains four glazing bar profiles 6. Each glazing bar profile 6 has an end 7 facing the spacer 4. The glazing bar profiles 6 are thin-walled hollow profiles. The glazing bar ends 7 are open on their front face and embedded directly in the material of the spacer 4, see FIGS. 2 and 3. The glazing bar profiles 6 and thus also the glazing bar insert 5 are therefore held in the spacer 4 without the use of glazing bar holders and/or glazing bar shoes. An external dimension AM measured along the glazing bar profile 6 over two opposite glazing bar ends 7 is 1 mm to 2 mm larger than the associated clear internal dimension IM1 of the spacer 4. The spacer 4 is formed by a pasty and subsequently solidifying strand 8 of a plastic-based material, which is applied to the glass sheet 2, see FIG. 4. In the area of the glazing bar ends 7 to be embedded, a section 9 of the pasty spacer strand 8 is bent plastically outwards by a bending-up force FA, see FIG. 5. The four bent sections 9 have an enlarged internal dimension IM2, which is larger than the associated external dimension AM. Before being bent open, the spacer strand 8 has a rectangular cross-section with a first narrow side 81, a second narrow side 82 and an inner side surface 83 and an outer side surface 84. The narrow side 81 of the spacer strand 8 is placed on the glass sheet 2 so that the side surfaces 83 and 84 extend perpendicular to the glass plane of the glass sheet 2. When bending open, the rectangular cross-section of the spacer strand 8 is slightly distorted in the section 9, as the narrow side 81 of the spacer strand 8 adheres to the glass sheet 2, see FIG. 9. After bending open, the glazing bar insert 5 is inserted into the spacer 4, see FIGS. 6 to 9. The sections 9 of the spacer strand 8 are then bent back again by a bending-back force FZ. In the process, the spacer strand 8 is returned to its original rectangular shape in the sections 9, so that the spacer strand 8 in the finished insulating glass pane 1 extends continuously in a straight line again in the area of the glazing bar ends 7, see FIGS. 1 and 2. When the sections 9 are bent back, the glazing bar ends 7 are pressed into the still pasty spacer strand 8 and thereby embedded, see FIGS. 2 and 3. Part of the material of the spacer strand 8 is pressed into the interior of the open glazing bar end 7, see in particular, FIG. 3.

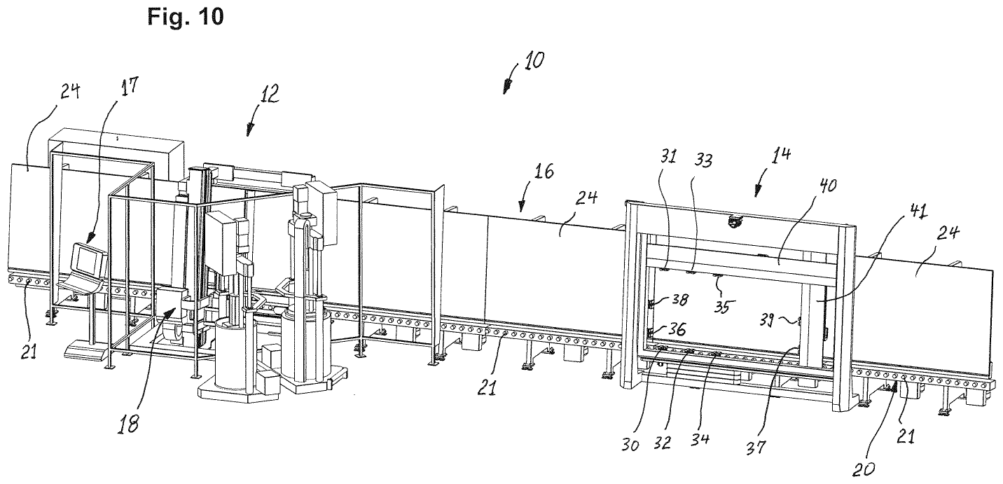

FIG. 10 schematically shows a device 10, often also referred to as a production line, for assembling the insulating glass pane 1, which comprises an application station 12 for the spacer bar 8 and a glazing bar station 14 for inserting the glazing bar insert 5. An intermediate station 16 is provided as a transport track and/or intermediate storage between the application station 12 and the glazing bar station 14. A computer control unit 17 is coupled to the device 10 in order to control it in the manner described. The application station 12 is configured in a manner known per se, for example according to DE 44 33 749 A1, for applying a pasty and then solidifying spacer strand of a thermoplastic material to a glass sheet and therefore does not need to be described in detail. In the application station 12, the spacer strand 8 is applied to the standing glass sheet 2 along its edge in a manner known per se. For this purpose, the application station 12 contains an application head 18, which is guided along at least one section of the edge of the glass sheet 2 for application. The paste-like spacer strand 8 solidifies over time after application to the glass sheet 2.

The device 10 contains one or more single-track horizontal conveyors 20, which are formed by a line of several drivable transport rollers 21. Such horizontal conveyors 20 are known per se. A glass sheet 2 stands on the horizontal conveyor 20 with its lower edge 22. Each of the stations 12, 14 and 16 has a supporting wall 24. The supporting wall 24 has an angle of 6° to 8° to the vertical, in a manner known per se, in order to support the glass sheet 2 leaning against it, which stands on the horizontal conveyor 20, and to prevent it from falling forwards unintentionally. In FIG. 10, the glass sheet 2 is conveyed into the application station 12 from the left. The spacer strand 8 is applied to the glass sheet 2 by the application head 18, resulting in the state shown in FIG. 4. The glass sheet 2 as shown in FIG. 4 is conveyed from the horizontal conveyor 20 via the intermediate station 16 to the glazing bar station 14. In the glazing bar station 14, the glazing bar insert 5 is inserted in the manner described below. The glass sheet 2 is thereafter conveyed by the horizontal conveyor 20 to a pressing station (not shown) and joined to the glass sheet 3 in a manner known per se to form the insulating glass pane 1 by placing the glass sheet 3 on the narrow side 82 of the spacer strand 8 and filling the space between the glass sheets 2 and 3 with a gas other than air.

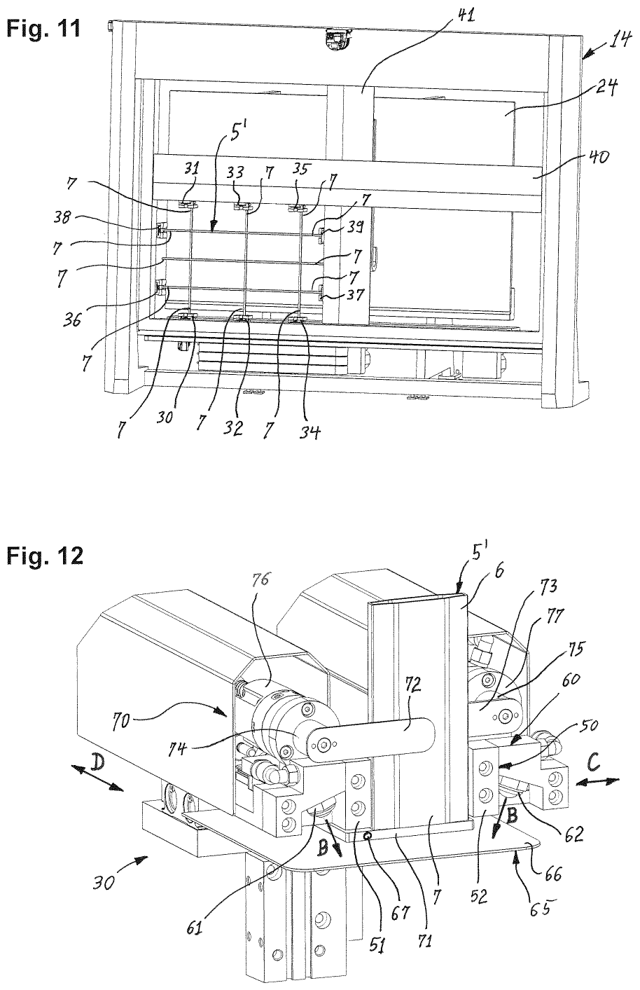

The glazing bar station 14 according to the invention contains ten processing heads 30, 31, 32, 33, 34, 35, 36, 37, 38, 39, the mode of operation of which is described with reference to the glazing bar frame 5′ shown in FIG. 11 having six intersecting glazing bars and twelve outwardly projecting glazing bar ends 7. The three processing heads 30, 32, 34 are arranged at the lower edge of the supporting wall 24 and can be moved horizontally to the right and left. The two processing heads 36 and 38 are arranged on the left edge of the supporting wall 24 and can be moved up and down parallel to the supporting wall 24. The glazing bar station 14 contains a horizontal guide beam 40, which can be moved up and down parallel to the supporting wall 24. The processing heads 31, 33 and 35 are arranged on the guide beam 40 so that they can be moved horizontally to the right and left. The glazing bar station 14 contains a vertical guide beam 41, which can be moved horizontally to the right and left. The processing heads 37 and 39 are arranged on the guide beam 41 so that they can be moved upwards and downwards parallel to the supporting wall 24. The glazing bar station 14 contains several drives (not shown) coupled to the control unit 17 for motorised displacement of the guide beams 40 and 41 and the processing heads to the positions at which the glazing bar ends 7 of the glazing bar insert 5′ to be inserted are located. The processing heads 31, 33, 35, 37, 39 can each be swivelled about an axis oriented perpendicular to the supporting wall 24.

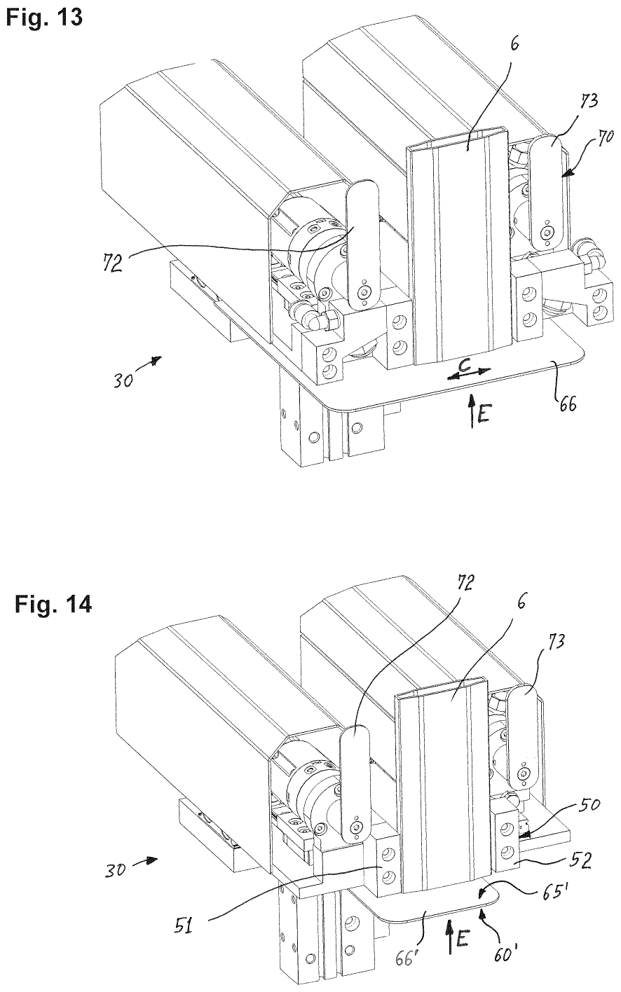

FIGS. 12 and 13 show a first example of a processing head 30. The processing head 30 contains a gripper 50 with two clamping jaws 51 and 52 and a bending-up device 60 having two blowing nozzles 61 and 62. The blowing nozzles 61, 62 can be pressurised with compressed air. The escaping compressed air generates flows of blown air, which are indicated by the arrows B in FIG. 12. The clamping jaws 51, 52 can be moved relative to each other along the double arrow C in order to perform a gripping movement by changing their distance to one another. The processing head 30 can be moved along the double arrow D perpendicular to the supporting wall 24. The processing head 30 also contains a bending-back device 65 comprising a strand bending plate 66 and a positioning aid 70 having a support plate 71 and two swivelling guide fingers 72 and 73. Each guide finger 72, 73 is non-rotatably fixed to a pivot shaft 74, 75. The guide fingers 72, 73 can each be swivelled back and forth between the positions shown in FIGS. 12 and 13 by a controlled drive 76, 77. The strand bending plate 66 can be moved in the direction of the arrow E relative to the clamping jaws 51, 52. A temperature sensor 67 coupled to the control unit 17 is arranged in the end face of the strand bending plate 66. The other processing heads 31, 32, 33, 34, 35, 36, 37, 38 and 39 are designed in the same way as the processing head 30.

Before inserting the glazing bar insert 5′ into the grippers 50, the processing heads 30, 31, 32, 33, 34, 35, 36, 37, 38 and 39 are moved to the positions required according to the dimensions of the glazing bar insert 5′ in order to grip its glazing bar ends 7, see FIG. 11. First, the clamping jaws 51 and 52 are moved with the blowing nozzles 56 and 57 (without the inserted glazing bar insert 5′) in direction C to a distance that corresponds to the desired length of the section 9 of the spacer strand 8 to be bent open. Then the processing heads 30, 31, 32, 33, 34, 35, 36, 37, 38 and 39 (without the inserted glazing bar insert 5′) are moved together in direction D towards the supporting wall 24 and the glass sheet 2 leaning against it. This brings the blowing nozzles 56 and 57 into a position within the spacer 4 in which the blown air flow B can act on the inner side surface 83 and bend the spacer strand 8 outwards. The strand bending plate 66 moves to a position in front of the outer side surface 84, where it can measure the temperature of the spacer strand 8. Depending on the measured temperature, the pressure of the blown air flow B can be adjusted in order to adapt the bending-up force FA to the strength of the pasty spacer strand 8. The spacer strand 8 is then bent outwards in ten sections 9. However, the glazing bar insert 5′ has twelve glazing bar ends 7, see FIG. 11. The processing heads 36 and 37 are therefore moved upwards to the required height and bend two more sections 9 of the spacer strand 8 outwards. The processing heads 36 and 37 are then moved back to the height shown in FIG. 11. All processing heads 30, 31, 32, 33, 34, 35, 36, 37, 38 and 39 are moved in direction D away from the supporting wall and the glass sheet 2. The clamping jaws 51 and 52 are opened. The guide finger 72 and the support plate 71 are in the position shown in FIG. 12. The guide finger 73 is still perpendicular to the support plate 71. In this position of the processing heads, the glazing bar insert 5′ is inserted into the grippers 50. The glazing bar insert 5′ can be placed with its glazing bar ends 7 on the support plate 71 and pressed against the guide finger 72. The guide finger 73 is then swivelled through 90° so that it is parallel to the guide finger 72, as shown in FIG. 12. The guide finger 73 is brought closer to the guide finger 72 in direction D to ensure that the glazing bar profile 6 rests against the guide finger 72. In such way positioned by the positioning aid 70, the glazing bar profile 6 is gripped by the clamping jaws 51 and 52. After closing the grippers 50, the support plate 71 is pulled back in direction D and the guide fingers 72 are each swivelled by 90° so that they are parallel to the glazing bar profile 6, see FIG. 13. This is done in all processing heads, whereby precise positioning of the glazing bar insert 5′ in the grippers 50 is achieved.

Now the processing heads 30, 31, 32, 33, 34, 35, 36, 37, 38 and 39 are moved together with the glazing bar insert 5′ held by the grippers 50 in direction D towards the supporting wall 24 and brought closer to the glass sheet 2. In the process, the glazing bar insert 5′, which is orientated parallel to the glass sheet 2, is inserted transversely to the plane of the glass into the space enclosed by the frame-shaped spacer 4 until it reaches the position shown in FIGS. 6 to 9. The glazing bar ends 7 do not yet touch the spacer strand 8, see FIG. 9. The bending plates 61 move with the processing heads in direction D and are each located outside the outer side surface 84. The glazing bar insert 5′ is firmly held in this position by the grippers 50, while the bending plates 61 are brought closer to the clamping jaws 51, 52 in direction E in order to apply the bending-back force FZ to the outer side surface 84 and bend back the bent-up sections 9, see FIGS. 9 and 13. Part of the material of the spacer strand 8 is pressed into the interior of the glazing bar profile 6, resulting in the state shown schematically in FIG. 3. The clamping jaws 51 and 52 of the processing heads 36 and 37 are then moved apart in direction C. The processing heads 36 and 37 are moved upwards to the glazing bar ends 7 of the centre horizontal glazing bar of the glazing bar insert 5′, see FIG. 11, and also embed these in the spacer strand 8 by bending back the bent-up sections 9. The glazing bar insert 5′ is still held in place by the other processing heads. Once all twelve glazing bar ends 7 of the bar insert 5′ have been embedded, all grippers 50 are opened and all processing heads 30, 31, 32, 33, 34, 35, 36, 37, 38 and 39 are moved away from the supporting wall 24. The glass sheet 2 with the glazing bar insert 5′ embedded in the spacer 4 is then conveyed out of the glazing bar station 14 by the horizontal conveyor 20. The glazing bar station 14 is now free again and can insert the next glazing bar insert.

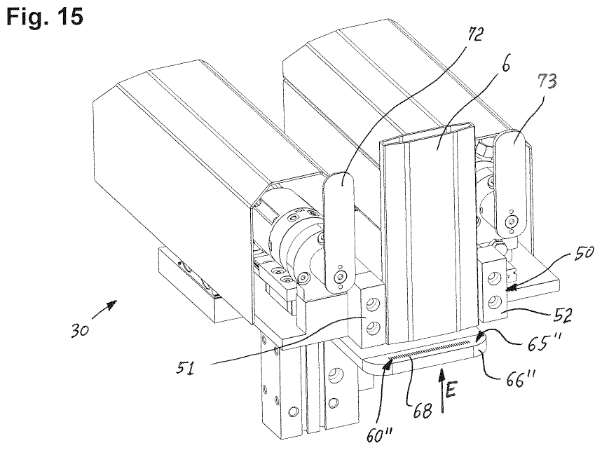

FIG. 14 shows a variant of the processing head 30, which does not contain blow nozzles but instead a narrower strand bending plate 66′. The side of the strand bending plate 66′ facing away from the clamping jaws 51, 52 acts as a bending-up device 60′. The side of the strand bending plate 66′ facing the clamping jaws 51, 52 acts as a bending-back device 65′. The sections 9 of the spacer strand 8 are thus bent outwards by the strand bending plate 66′ instead of by a flow of blown air. FIG. 15 shows a variant of the processing head 30 in which the bending-up device 60″ is formed by a suction device. The strand bending plate 66″ has a suction opening 68 on its side facing the clamping jaws 51, 52. The suction opening 68 can be used to suck the outer side surface 84 of the spacer strand 8 onto the strand bending plate 66″ in order to bend open the section 9. Apart from that, the variants shown in FIGS. 14 and 15 work in the same way as the processing head 30 shown in FIGS. 12 and 13, so that a repeated description can be dispensed with.

### LIST OF REFERENCE SYMBOLS

1 Insulating glass pane
2 First glass sheet
3 Second glass sheet
4 Spacer
5,5′ Glazing bar insert
6 Glazing bar profile
7 Glazing bar end
8 Spacer strand
9 Section
10 Device
12 Application station
14 Glazing bar station
16 Intermediate station
17 Control unit
18 Application head
20 Horizontal conveyor
21 Transport rollers
22 Lower edge
24 Supporting wall
30 Processing head
31 Processing head
32 Processing head
33 Processing head
34 Processing head
35 Processing head
36 Processing head
37 Processing head
38 Processing head
39 Processing head
40 Guide beam
41 Guide beam
50 Gripper
51 Clamping jaw
52 Clamping jaw
60, 60′, 60″ Bending-up device
61 Blowing nozzle
62 Blowing nozzle
65, 65′, 65″ Bending-back device
66, 66′, 66″ Strand bending plate
67 Temperature sensor
68 Suction opening
70 Positioning aid
71 Support plate
72 Guide finger
73 Guide finger
74 Pivot shaft
75 Pivot shaft
76 Drive
77 Drive
81 First narrow side
82 Second narrow side
83 Inner side surface
84 Outer side surface
AM External dimension
IM1 Internal dimension
IM2 Enlarged internal dimension
B Blown air flow
C Direction of movement
D Direction of movement
E Direction of movement
FA Bending-up force
FZ Bending-back force

What is claimed is:

1. An insulating glass pane, comprising:
at least two glass sheets, a frame-shaped spacer and a glazing bar insert;
wherein the glazing bar insert is mounted inside the spacer between the two glass sheets; and
wherein the glazing bar insert contains at least one elongated glazing bar profile with a glazing bar end facing the spacer;
wherein at least one glazing bar end is formed by a glazing bar profile being formed as hollow profile and is embedded in the plastic-based material of the spacer wherein that part of the plastic-based material is present in the interior of the hollow profile.

2. The insulating glass pane according to claim 1, in which the glazing bar insert has two opposite glazing bar ends facing the spacer, which are each formed by a glazing bar profile being formed as hollow profile and are embedded in the plastic-based material of the spacer, wherein plastic-based material of the spacer is present in the interior of the hollow profile at both glazing bar ends.

3. The insulating glass pane according to claim 2, in which the glazing bar insert has an external dimension (AM) measured along the glazing bar profile over the two opposite glazing bar ends, which is greater than the associated internal dimension (IM1) of the frame-shaped spacer.

4. A device for assembling an insulating glass pane containing at least two glass sheets, a frame-shaped spacer and a glazing bar insert, wherein the device comprises:
a glazing bar station which is configured for inserting a glazing bar insert into a pasty and subsequently solidifying spacer strand which has been applied to a glass sheet in the form of a frame along its edge;
wherein the device contains at least one bending-up device which is configured to plastically bend outwards a spacer strand applied to a glass sheet; and
wherein the device contains at least one bending-back device which is configured to plastically bend back a bent-open spacer strand after insertion of a glazing bar insert.

5. The device according to claim 4, including at least one movable processing head, which contains a gripper and the bending-up device and/or the bending-back device, wherein the gripper has two clamping jaws, the distance between which is variable for gripping a glazing bar profile.

6. The device according to claim 5, wherein the processing head comprises at least one positioning aid, which is configured to position a glazing bar insert to be inserted between the clamping jaws.

7. The device according to claim 4, wherein the bending-up device and/or the bending-back device contains at least one strand bending plate.

8. The device according to claim 4, wherein the bending-up device comprises at least one blowing nozzle.

9. The device according to claim 4, wherein the bending-up device is designed as a suction device, which has a suction opening and is configured to pull on a spacer strand by suction.

10. A method of assembling a first glass sheet, a frame-shaped spacer, a glazing bar insert and a second glass sheet to form an insulating glass pane, comprising the following steps:
providing the spacer in the form of a spacer strand made of a pasty and subsequently solidifying plastic-based material;
applying the spacer strand to the first glass sheet in the shape of a frame;
after applying the spacer to the first glass sheet, bending at least one section of the still pasty spacer strand outwards;
inserting the glazing bar insert into the frame-shaped spacer and bending the bent-open spacer strand back wherein at least one glazing bar end of the glazing bar insert is pressed into the still pasty spacer strand;
after embedding the glazing bar end in the spacer strand, placing a second glass sheet on the frame-shaped spacer wherein the spacer and the glazing bar insert are located between the first glass sheet and the second glass sheet.

11. The method according to claim 10, wherein, by using a bending-up device, a bending-up force (FA) is applied to a side surface of the spacer strand in order to plastically deform the spacer strand, wherein said side surface is orientated transversely to a glass plane of the first glass sheet.

12. The method according to claim 11, wherein the bending-up force (FA) is applied by subjecting the spacer strand to a flow of blown air (B).

13. The method according to claim 10, wherein, by using a bending-back device, a bending-back force (FZ) is applied to a side surface of the spacer strand in order to plastically deform the spacer strand, wherein said side surface is orientated transversely to a glass plane of the first glass sheet.

14. The method according to claim 10, wherein the bending-up force (FA) and/or the back-bending force (FZ) is controlled on the basis of the temperature of the spacer strand.

15. The method according to claim 10, wherein the spacer strand is plastically deformed by a strand bending plate during bending open and/or during bending back.
